(19) United States
(12) Patent Application Publication
(10) Pub. No.: US 2026/0204928 A1
(43) Pub. Date: Jul. 16, 2026

(54) CASING ARRANGEMENT, ELECTRONIC DEVICE AND METHOD FOR OPERATING AN ELECTRONIC DEVICE

(71) Applicant: Nomono As, Trondheim (NO)

(72) Inventors: Viktor Emil RYDAL, Trondheim (NO); Andreas LOHRE, Trondheim (NO); Eivind SÆTER, Trondheim (NO); Trond Egil GRAN, Trondheim (NO)

(21) Appl. No.: 19/130,882

(22) PCT Filed: Nov. 16, 2023
(86) PCT No.: PCT/EP2023/082139

§ 371 Date: May 16, 2025

(30) Foreign Application Priority Data
Nov. 18, 2022 (DK) PA 2022 70569

(51) Int. Cl. H02J 7/50; G06F 1/16; G06F 1/3212; G06F 1/3246; H02J 7/34; H02J 7/70; H02J 7/82; H02J 7/90; H02J 7/96

(52) U.S. Cl. CPC H02J 7/50; G06F 1/1632; G06F 1/3212; G06F 1/3246; H02J 7/342; H02J 7/731; H02J 7/82; H02J 7/96; H02J 7/971; H02J 2207/30

(57) ABSTRACT

The invention concerns a casing arrangement, comprising a casing bottom part having a recess configured to accommodate a rechargeable electronic device therein; and a casing top part configured to be attached to the casing bottom part for covering the rechargeable electronic device accommodated in said recess. A sensor unit is arranged in the casing bottom part and configured to provide a status signal in response the casing top part being attached to the bottom part. The casing bottom part is configured to recharge the electronic device when accommodated in the recess based on a respective recharging signal provided by a charge control circuit. The charge control circuit is configured to hibernate the electronic device and terminate any recharging of the electronic device in response to the status signal indicating that the casing top part is attached to the casing bottom part and a pre-determined charging state of the electronic device.

The present application claims priority from Danish application No PA 202270569 dated Nov. 18, 2022, the disclosure of which is incorporated herein by reference in its entirety.

The present invention concerns a casing arrangement, in particular for recording devices. The present invention also refers to an electronic device, a system of casing arrangement and electronic device and to a method for operating an electronic device, in particular a recording device.

### BACKGROUND

In the prosumer market is a need for portable recording device that enable a user to record audio and/or video content without having a continuous power supply that is a power supply connected directly to the main grid. Such devices usually include a rechargeable battery that can either be embedded in the recording device but may also be replaceable in some other instances. The rechargeable device is usually specified by a dedicated capacity, given in mWh indicating the operation time of the recording device under normal circumstances. While this capacity for rechargeable batteries is usually set to sizes sufficient for several minutes and even hours of recording, extensive operation or external parameters can influence the operation time. Aging may also impact the overall operation time. Additional functionalities, like transmitting the recorded material or processing it in certain ways increase the power consumption, and consequently the recording or standby time decreases.

Recording sessions are usually interrupted for various reasons, e.g. for preparation of the actors, interviewers, and the like, but also because of change in location. During the interruption of the operation of such electronic devices in different sessions, one may recharge the electronic device using a so-called power bank, which is simply speaking another larger energy store. While such approach is useful and often sufficient, particularly when no power supply to the grid is available, a continuous power consumption of the electronic device may still be an issue. In addition to this, more complex electronic devices that facilitate pre-processing or transmission of the recorded material may utilize the time between recording sessions and therefore cannot just be switched off to save power.

Consequently, there is a need to provide a more flexible solution that ensures a sufficient high charge state for the battery in the electronic device, while allowing a user to follow his or her individual workflow in a flexible manner.

### SUMMARY OF THE INVENTION

This and other objects are addressed by the subject matter of the independent claims. Features and further aspects of the proposed principles are outlined in the dependent claims.

The inventors propose an intelligent method for reducing the power consumption while maintaining flexibility and ensuring that a portable device, particular a portable recording device has sufficient battery charge to enable recording sessions. This is achieved by proper control & communication between the casing on the one hand and the various electronic devices, i.e. the recording devices on the other hand. To facilitate the communication and reduce complexity, the inventors propose a master-slave approach, whereas a control circuit receives various status signals and control charging of the respective devices, while also considering the operating state as such.

In an aspect of the proposed principle a portable casing arrangement comprises a casing bottom part and a casing top part. The casing bottom part comprises a stand and further includes a first recess configured to accommodate a first rechargeable electronic device therein. The casing top part is configured to be attached to the casing bottom part opposite the stand for covering said first rechargeable electronic device when being accommodated in said recess.

In other word, the electronic device can be placed in the casing bottom part and subsequently covered by the casing top part in order to be carried or otherwise managed.

In accordance with the proposed principle, a sensor unit is arranged in one of the casing top part and the casing bottom part and configured to provide a status signal in response to the casing top part being attached to the casing bottom part. Hence, the sensor can detect whether the casing is closed and or open irrespectively of the electronic device being arranged therein. The casing bottom part is further configured to recharge the first electronic device when the first electronic device is accommodated in said first recess based on a respective recharging signal provided by a control circuit. Said control circuit is also configured to hibernate the first electronic device and terminate any recharging of the first electronic device in response to the above-mentioned status signal indicating that the casing top part is attached to the casing bottom part and a pre-determined charging state of the first electronic device.

In accordance with the present invention, the proposed arrangement ensures that charging of the electronic device accommodated within the closed casing continues until a pre-determined charging state is reached irrespective of the status, which is whether the casing is closed and can be carried around or opened. Hence, the electronic device can be charged while a user is moving from one place to another carrying the arrangement. On the other hand, the electronic device is automatically hibernated during this time, when it is charged to the predetermined state and the casing is still closed.

The term “hibernate state” in this regard refers to a status of the electronic device, in which the main electronic if not all electronics are powered down and the overall power consumption is greatly reduced, i.e. by a factor of 50 to 200 or even more. Power consumption is minimized. In some occurrences with electronic devices using electronic switches, the expression “hibernate” may refer to a state, in which the electronic device is switched off and needs to mechanically be switched back on (i.e. by pressing a button). The status “hibernate” may the last state of the device, i.e. a user can continue working afterwards. This status is different to a sleep mode, in which erasable memory is refreshed periodically (which is not the case in the status “hibernate”.

In some aspects, the control circuit is arranged in the first electronic device. In other words, the electronic device becomes its own master, but relies on the sensor signal provided by the casing bottom part to determine whether the case is closed or not. This is beneficial, as such arrangement and particular evaluating a sensor signal from the casing prevents so called false-positive signals. Communication between casing and the electronic device could, in such arrangement be limited to the charging control signals and the evaluation signal of the sensor.

Likewise, the pre-determined charging state is indicative of a voltage level of the rechargeable battery within the electronic device when being arranged within the recess.

The proposed master-slave approach can be further extended to control also the charging of further electronic devices, i.e. satellite portable microphones. In some aspects, the casing bottom part comprises at least one second recess configured to accommodate a second rechargeable electronic device therein. The casing bottom part is now configured to recharge the second electronic device when accommodated in said second recess based on respective recharging signal provided by the charge control circuit. In other words, the charge control circuit is configured to control the recharging of all electronic devices when being accommodated in respective recesses of the casing. This recharging is however dependent on a status signal indicative of the charging state of the respective electronic device and the status signal concerning the casing itself, i.e. whether it is closed or not.

Hence, in some aspects, the control circuit is configured to obtain a charging state signal from the first electronic device and/or the second electronic device indicative of a state of a rechargeable battery placed in the respective first and second device. In addition, the control circuit may be configured in some instances to hibernate the second electronic device and terminate any recharging of the second electronic device in response to the status signal indicating that the casing top part is attached to the casing bottom part and a pre-determined charging state of at least one of the first and the second electronic device.

The proposed principle enables the control circuit as a master to control the charging of the receptive electronic devices and hibernate them, once the predetermined charging state is met and the casing is closed, i.e. the casing is configured for transportation.

In some aspects, the casing is portable and not always connected to the main power grid. In such cases, the casing bottom part may comprise a rechargeable battery and a charging controller for charging the rechargeable battery when the casing bottom part is connected to a power supply, in particular a USB port or a USB Power Delivery connection. The rechargeable battery in the casing bottom part provides a high capacity such that it enables the control circuit to charge the first and/or second electronic device multiple times. The control circuit as well as the charging controller may be separate entities. Consequently, the charging controller is configured to charge the rechargeable battery in the bottom casing part irrespectively of the status signal, which is irrespectively whether the casing is closed or not.

In some instances, the sensor unit is configured to provide a first status signal, said first status signal indicating that the casing top part is attached to the casing bottom part and a second status signal, said second status signal indicating that the casing top part is removed from the casing bottom part. The latter signal may be used to initiate a reboot or wake-up the respective electronic devices from their respective hibernate state. Consequently in some aspects, the control circuit is configured to receive the second status signal and ins response thereto wake-up at least one of the first and second electronic devices, when the respective electronic device is hibernated.

Some aspects concern the sensor unit. It is advisable to provide a robust unit the is able to detect the closure of the casing, preferably without being prone to errors. In some instances, the sensor unit comprises a light detector. The light detector may be arranged in the bottom part in such way that it detects light reflected from the top casing when the casing is closed. For such purpose, the sensor unit may comprise a light source. The detector portion may comprise a filter to reduce ambient portions of the light spectrum and improve the signal to noise ratio. To prevent accidental detection (i.e. a hand covering the sensor etc, the sensor may include two spatially arranged detectors.

In some instances, the sensor unit may comprise a detector in one part and a light source in the other part of the casing. By modulating the light source and detecting this modulation, an error free detection can be made. The sensor unit can be configured in some instances to detect infrared light or light from a visible portion of the spectrum. The sensor may be purely passive, i.e. only detecting the ambient light or a transceiver as outlined previously having a detector element and a light source.

As an alternative, the sensor unit may comprise a hall sensor or a hall sensor switch. The hall sensor provides a voltage signal in response to a magnetic field or more precisely in response to a change of a magnetic field. By including a magnet in the upper part of the cases and placing one or more hall sensors in the lower part, the magnetic field may change when the casing top part of the casing is attached to the casing bottom part, thereby producing a voltage signal. As a further alternative, the sensor unit may comprise a mechanical push or pull sensor, for example a button that is pushed by the casing top part when being attached to the casing bottom part.

In an even easier solution, the sensor unit may comprise an electrically interrupted signal line, which is closed, when the casing top part is attached to the casing bottom part.

In some instances, the casing top part is configured to enhance the detection and thus the generation of a correct status signal. For example, the casing top part can be opaque thereby reducing the ambient light when the casing is closed. The casing top part may also comprise a reflective portion facing the sensor unit and, in some instances, the light source thereof. In some other instances, the casing top part may comprise a protrusion along the inner wall of the top part at a location at which the distance between its surface and the sensor unit is less than 5 cm and in particular less than 2 cm and in particular less than 1 cm when the casing top part is attached to the casing bottom part. A small distance will improve the signal to noise ratio and thus enhance detection.

It should be noted in this regard that with respect to the sensor unit, casing top part and casing bottom part can be exchanged without deviating from the proposed idea. Hence, the senor unit can be placed in the casing top part as long as a data connection for the respective status signal is maintained.

Some further instances of the casing arrangement in accordance with the proposed principle concern the arrangement of the electronic devices in the recess. For example, the first recess and/or the at least second recess can comprise means for pulling the respective electronic device towards a bottom of the recess as soon as the respective electronic device is located with its bottom portion in the vicinity of the recess, i.e. slightly below the top surface of the recess or even slightly above the recess. The means can include magnetic stripes exerting a pulling force of the electronic devices towards the bottom of the recess.

The force may be strong enough to hold the electronic devices in the recess during normal transportation vibrations but may also ensure an electrical connection of the device to enable correct charging and data communication. In this regard, the first and/or the second recess may comprise a plurality of electric connectors in some instances, in particular pogo-pins for electrically connecting the respective electronic device when arranged in the respective recess.

To prevent arrangement of the electronic devices in the wrong recesses or with a wrong rotation, the shape and form of the recesses may vary accordingly. In some instances, one of the first recess and the electric connectors are shaped and/or located such that they ensure a non-rotating arrangement of the respective electronic device in the respective first and second recess. Hence, the respective electronic device can only be inserted into the recess when having the correct orientation.

In some instances, the casing arrangement further comprises a bus system that includes a communication bus for communicating with the first and/or second electronic device. The communication bus comprises one of USB, SPI, or I2C bus. Depending on the Bus system, charging power can also be applied form the casing to the respective electronic device, reducing the overhead and mechanically needed connectors.

Some other aspects concern an electronic device for recording audio and/or video data. The electronic device is configured to be placed into a casing arrangement according to the proposed principle.

To facilitate the above-mentioned functionality, the electronic device comprises an electrical connector for communicating from and to and transferring power from the casing arrangement. The electronic device also comprises a rechargeable battery coupled to the electrical connector for being recharged by the casing arrangement. Finally, there is a control circuit that is configured to control the charging of the rechargeable battery by the casing arrangement when the electronic device is arranged in the casing arrangement. The control circuit is further configured to hibernate the electronic device as well as terminate any recharging of the electronic device in response to a status signal provided by the sensor unit arranged in the casing bottom part of the casing arrangement indicating that the casing arrangement is closed and a pre-determined charging state of the electronic device.

Consequently, the control circuit is arranged in the electronic device, but apart from controlling the charging, it also receives certain status signals from the casing to determine the further charging. This enable the electronic device to be in control of the charging procedure.

In some further aspects, the control circuit is further configured to control the charging of a rechargeable battery of a second electronic device accommodated in the casing arrangement. While charging itself is performed by the casing arrangement, the necessary control signals therefor are applied through the electrical connector. If needed the second electronic device may be configured to set the charging current and/or charging voltage.

The first electronic device and more particular the control circuit thereof is also configured to hibernate the second electronic device through the electrical connector by a respective signal. It also terminates any recharging of the second electronic device in response to a status signal provided by the casing arrangement indicating that the casing arrangement is closed and a pre-determined charging state of one of the first and second electronic devices.

Thereby, the control circuit is configured to charge any of the electronic devices up to a certain threshold and charging level, respectively. The charging level can either be either pre-set or indicated by the respective device and in response to the status of the casing. This will stop recharging and switch them to hibernation once they are fully loaded and the casing is closed indicating for instance a transportation or non-usage mode by the user. This will reduce the power consumption, but at the same time maintain any functionality which is still currently required. For example, the first and/or the second electronic device may still perform some processing, while the casing is closed. In such case, the control circuit will initiate charging and prevent hibernation until the processing is completed. If the necessary conditions are met, i.e. charging level reached, processing completed and status signal still indicating that the casing is closed, then the control circuit will set the respective devices into hibernation.

In some instances, the control circuit is configured to determine voltage level of the rechargeable battery of the first and/or the second electronic device and compare the determined voltage level with a threshold value. In addition, the control circuit may be configured to control the charging current based on the comparison result. Likewise in some instances, some circuitry in the respective devices may conduct the comparison and generate a corresponding charging state signal that is subsequently evaluated by the control circuit. In some further instances, the electronic device may also comprise a sensor element, in particular a light or infrared detector coupled to the charge control circuit. The control circuit is configured to change the operating status of the electronic device in response to a signal provided by the sensor element. In particular it may be used to put the electronic device in a low power or even the previously mentioned hibernate mode.

Some further aspects involve the waking up procedure after the first and/or second electronic device has been put into hibernation. In some instances, the control circuit is further configured to wake up at least one of the first and second electronic devices in response to another status signal provided by the sensor unit arranged in the casing bottom part of the casing arrangement indicating that the casing arrangement is opened. In case, the electronic device comprises a respective sensor element, said signal can also be provided by said sensor element. The control circuit may generate in response to the status signal a wake-up signal and provide it through the communication in the casing to the second electronic device. Consequently, the electronic device will ramp or boot up and can be directly use after the user opens the casing.

In some further instances, the first and/or second electronic device may comprise a display. The control circuit in this regard may be configured to switch-off the display in response to a signal received via the electrical connector from the sensor unit arranged in the casing bottom part indicative that the casing arrangement is closed. Similar, said signal may also be provided by the sensor element in the respective device. This already reduce power consumption while maintaining the other functionalities of the device. Apart from a display other parts or modules of the device, like the user interface, the microphone section and such can be deactivated once the status signal indicates that the casing is closed.

The electronic device may comprise different functionalities and/or can be implemented as such. For example, the first and/or second electronic device may comprise an audio recording device, a video recording device, a display device, and/or a combination of those devices.

Some other aspects concern a method for operating an electronic device. Said electronic device is accommodated in a recess of a casing bottom part of a casing arrangement and is in in electrical connection with a casing bottom part of the casing arrangement. Said casing bottom part comprises some of the above-mentioned aspects, in particular an energy storage that is suitable to recharge the electronic device accommodated in said recess.

The method comprises recharging the electronic device in response to a charge state signal. The casing bottom part generates a first sensor signal indicative that the casing bottom part is covered by a casing top part. The first sensor signal is provided to the electronic device via the electrical connection. In response to the received first sensor signal and a pre-determined charging state of electronic device the electronic device will be hibernated, and any recharging of the electronic device is terminated. This approach provides a flexible way to reduce power consumption on an as need basis and to control the charging of the electronic devices. The electronic device therefore can continue with some processes even during transportation or non-use (i.e. transmitting recorded data to a cloud and the like.

In some aspects, at least one further electronic device is accommodated in a recess of a casing bottom part of a casing arrangement. The at least one further electronic device bay also be controlled in response to the received first sensor signal and a pre-determined charging state of electronic device. For example, if both conditions are met, the at least one further electronic device is hibernated and any recharging of the at least one further electronic device is subsequently terminated.

In some further aspects, a second sensor signal is generated by the casing bottom part indicative that the casing bottom part is no longer covered by a casing top part. Said second sensor signal is provided to the electronic device via the electrical connection, i.e. it is provided from the casing bottom part to the control circuit within electronic device accommodated in the recess. In response to the reception of such second sensor signal, the electronic device and/or the at least one further electronic device is woken up. For this purpose, a respective wake up-signal may be generated by the control circuit and subsequently provides to the other circuitry of the first and/or the at least one further electronic device.

### SHORT DESCRIPTION OF THE DRAWINGS

Further aspects and embodiments in accordance with the proposed principle will become apparent in relation to the various embodiments and examples described in detail in connection with the accompanying drawings in which

FIG. 1 shows a schematic view of a casing arrangement with some electronic devices arranged in respective recesses illustrating some aspects in accordance with the proposed principle;

FIG. 2 illustrates a top view of a bottom part of a casing arrangement in accordance with some aspects of the proposed principle;

FIG. 3 shows a block diagram of an embodiment of a system with a casing arrangement and two electronic devices illustrating some aspects of the proposed principle;

FIG. 4 illustrates a block diagram of another embodiment of a system with a casing arrangement and an electronic device in accordance with some aspects of the proposed principle;

FIG. 5 shows a method for operating an electronic device in accordance with some aspects of the proposed principle.

### DETAILED DESCRIPTION

The following embodiments and examples disclose various aspects and their combinations according to the proposed principle. The embodiments and examples are not always to scale. Likewise, different elements can be displayed enlarged or reduced in size to emphasize individual aspects. It goes without saying that the individual aspects of the embodiments and examples shown in the figures can be combined with each other without further ado, without this contradicting the principle according to the invention. Some aspects show a regular structure or form. It should be noted that in practice slight differences and deviations from the ideal form may occur without, however, contradicting the inventive idea.

In addition, the individual figures and aspects are not necessarily shown in the correct size, nor do the proportions between individual elements have to be essentially correct. Some aspects are highlighted by showing them enlarged. However, terms such as “above”, “over”, “below”, “under” “larger”, “smaller” and the like are correctly represented with regard to the elements in the figures. So it is possible to deduce such relations between the elements based on the figures.

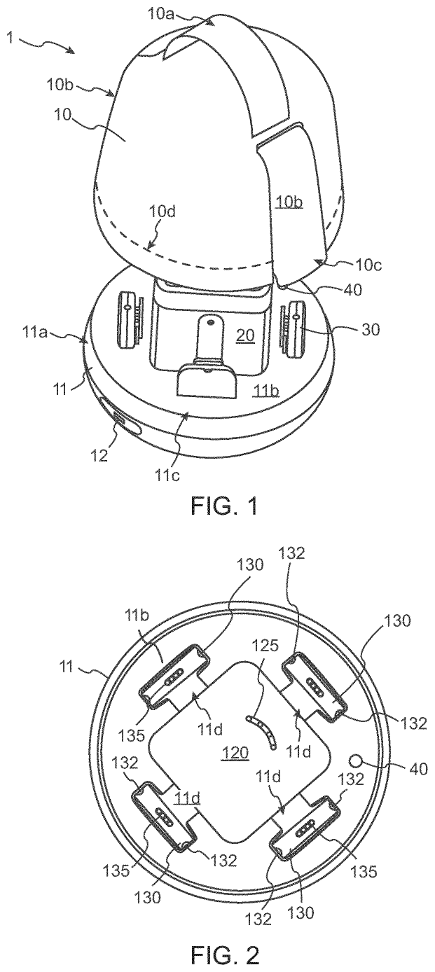

FIG. 1 shows a casing arrangement illustrating several aspects of the proposed principle. The casing arrangement comprises a casing top part 10 and a casing bottom part 11. The casing top part 10 is formed as a hat-shaped hollow closure with a handle 10a at its top. TWO mechanical clamps 10b are arranged on each site of the casing top part 10. The two mechanical clamps comprise an upper portion that are rotatable and movable upwards and downwards. Upon such movement the clamps 10b are also rotating slightly, such that its lower portion extends outwards as illustrated in FIG. 1. The lower portion comprises an inward facing protrusion that fits into a recess formed by a protrusion between surface 11b and circumferential edge 11a of the casing bottom part 11. It tightly connects with the protrusion 11c when the casing top part 10 is arranged on the bottom part and the two mechanical clamps 10b are pressed inwards.

The casing top part 10 is then rigidly attached to the casing bottom part 11. Friction of the circumferential edge surfaces between the casing top part 10 and the casing bottom part 11 is large enough to prevent rotation of both parts with respect to each other. The closed casing arrangement can then be moved and transported using handle 10a.

The casing top part is made of an opaque plastic material and comprises a circumferential protrusion 10d on its inner side illustrated herein as dotted line. A distance of the protrusion 10d to the lower surface of the casing top part 10 (the surface is then resting on the circumferential edge 11a of casing bottom part 11) is slightly larger than the respective distance between upper surface 11b and surface edge 11a. Consequently, the protrusion 10d does not lie on the surface 11b of the casing bottom part 11.

Casing bottom part comprises a stand, such it can be placed on any horizontal plane. The casing bottom part comprises a charging plug 12 on its side for connecting the casing bottom part to a USB charger and the like. Casing bottom part 11 also comprises a circumferential edge 11a configured to have the lower surface of casing top part resting upon when the casing is closed. A small circumferential protrusion edge 11c is displaced to surface edge 11a.

A plurality of recesses is arranged on the top surface 11b of the casing bottom part 11. Those recesses are filled in the embodiment of FIG. 1 with a plurality of rechargeable electronic devices 20 and 30. In particular casing bottom part 11 comprises a central recess for accommodating a first rechargeable electronic device 20 with an additional recess on each side for accommodating in total up to four second rechargeable electronic devices 30. the casing bottom part also comprises a sensor unit 40, in the present embodiment a light sensor 40. Light sensor 40 is arranged in the top surface at a position facing the circumferential protrusion 10d of the casing top part when the casing top part 10 is placed on the bottom part 11. In this regard, the inner part of casing top part 10 may be configured in such way as to substantially hold the rechargeable electronic devices in place, when they are accommodated in the respective recesses and the casing is closed.

Referring now to FIG. 2 illustrating a view from the top onto the surface 11b of casing bottom part 11.

As already mentioned, the casing bottom part 11 comprises five recesses, one central recess 120 and four recesses 130 surrounding the central recess. The central recess 120 is connected to the surrounding recess by a bridge 11d in between, also slightly recessed with regards to surface 11b. The second rechargeable electronic devices 30 comprise a clamp (for attaching the device to a suers cloth or body) attached to one side which fits into the area between the central recess and one of the respective four recesses. Hence, although the recesses 130 are symmetric, the material bridge 11d will interact with the second rechargeable electronic devices when being place within recesses 130, ensuring that the second rechargeable electronic devices can be accommodated within recess 130 only in a pre-determined orientation.

A slightly curved connector pad 125 having a plurality of pogo pins is arranged on the bottom of the central recess 120. The position of the connector pad 125 is selected such that the pogo pins connect respective contacts on the bottom of the first rechargeable electronic device 20 when being accommodated in the central recess 120. The connector pad 125 is displaced with respect to the centre of recess 120. This will prevent accommodation of the first rechargeable electronic device 20 in a wrong orientation within central recess 120. As an alternative to the single connector pads 125, two or more separate connector pads can be utilized to provide electrical connection between the first electronic device and the casing bottom part. It is however advisable to either place them in some asymmetric fashion or provide other mechanical means to prevent misorientation of the first rechargeable electronic device 20 when being accommodated in the recess central 120.

Recesses 130 each comprise a centrally oriented connector pad 135 having four pogo-pins. The pogo-pins are configured to interact with respective bottom contacts of second rechargeable electronic device when accommodated on the recesses 130. The four recesses 130 also include two magnetic slides 132 on each side as illustrated. The magnetic slides also interact with the second electronic devices when those are placed in close vicinity of the recesses.

In particular the slides 132 are pulling the respective rechargeable electronic devices 30 towards the bottom of the recess 130 when the respective electronic devices 30 are located with its bottom portion in the recess at a level slightly below the top surface of the recess 130. The slides 132 are symmetrically arranged, however, they may have different shapes such that the slides 132 also ensure correct orientation of the second electronic devices in the respective recesses 130. The magnetic slides elements 135 keep the second rechargeable electronic devices 30 in place when being accommodated in the recess, such that the contact between the second rechargeable electronic devices 30 and the pogo-pins of contact pads 135 are maintained.

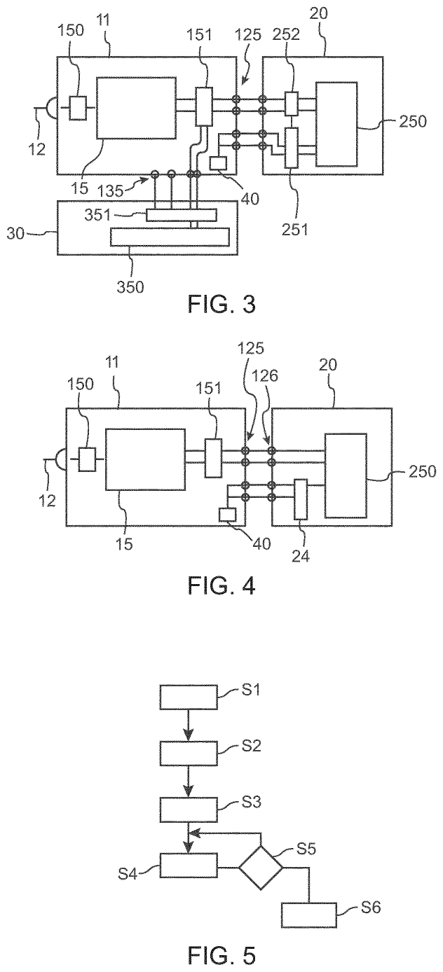

Operation of the casing arrangement according to the proposed principle and additional elements are explained in greater detail with regards to FIG. 3. The casing bottom part 11 comprises a large energy storage, e.g. a large rechargeable battery 15. The rechargeable battery comprises a capacity of more than 1000 mWh for example, which is enough to recharge the first and second rechargeable electronic devices multiple times.

The rechargeable battery 15 is connected on one side via a first bus to a charging control circuit 150 to the USB port for recharging at port 12. Charging control circuit 150 therefore controls the recharging of rechargeable battery 15 when the bottom casing part is plugged into the power grid or any transformer providing a DC current. The control of recharging battery 15 is independent of the electronic devices being accommodated therein and may also occur when the casing arrangement is opened. First bus is a USB bus for example, but any other bus protocol and arrangement suitable for control and charging signals can be used.

The rechargeable battery 15 is also connected to a bus interface 151 including (but not mandatory) further circuitry to provide control and charging signals to some of the pogo-pins at connector pad 125 positioned in the central recess 120. The bus interface 151 also connects the rechargeable battery 15 to pogo pins of connector pad 135 positioned in the recess for the second electronic devices (only one connection is shown here for illustrative purposes). The casing bottom part 11 also comprises a light sensor 40 that is also connected to the bus interface and connector 125. The light sensor 40 in the present embodiment is configured to detect ambient light and provide a respective status signal to the bus interface, which is subsequently provided as status signal on the connect pad 125.

Light sensor 40 will detect the ambient light, when the casing arrangement is opened. However, as soon as the casing arrangement is closed by covering the casing bottom part with the casing top part, the amount of ambient light reaching the sensor 40 will sharply decline. This decline and a continuously low level of ambient light detected by sensor 40 indicates that the casing bottom part is covered by the casing top part. Still, the signal may be erroneous, for example, if the sensor 40 is accidentally covered. To prevent such faulty signal, it is advisable to provide a second sensor arranged at a different location on the top surface. If both signals indicate a low level of ambient light, it can be assumed that the casing is closed.

As an alternative for such sensor, sensor unit 4 comprises a light source emitting light of a specific wavelength, for example in the IR spectrum. A detector of unit 4 located adjacent to the source is sensitive for this wavelength, e.g. by providing a respective bandpass filter covering the sensor. The casing top part 10 now comprises a reflective surface on its internal protrusion 10d. When placed on the casing bottom part, the reflective surface reflects a large portion of the light provided by the light source of sensor unit 4 to its detector. Modulating the light source compensates for accidental detection of ambient IR light and improves the determination whether the casing is closed or open.

As a further alternative, the sensor unit 4 comprises a magnetic sensor, for example a hall sensor. The bottom of the casing top part 10 includes some magnetic elements, such that when the casing top part is placed on the bottom part, the magnetic sensor will react to the field deviation caused by the magnetic elements. Similarly, more than a single magnetic sensor can be located on the circumference of the casing bottom part 11 to enhance detection. Finally, the protrusions of 10c of mechanical clamps 10b could be used to connect to a mechanical sensor indicating that the claims 10b are closed.

The sensor unit 40 provides a respective status signal indicating whether the casing top part is placed on the bottom part or not. The sensor unit provides the status signal 40 via the bus interface 151 to the respective contacts and pogo pins of contact pad 125.

First electronic device 20 is a portable device having a rechargeable battery 250. The capacity of battery 250 is smaller than one of rechargeable battery 15. A charging control circuit 252 is connected to the battery 250 and also connects to some contact pins 126 of the first electronic device. The contact pins 126 are in contact with respective contact areas of the contact pad 125 when the first electronic device is accommodated in the recess. Charging current is provided by the casing bottom part 10 via the contact pad areas 125 to connector pad and contact pins 126 and charging control circuit 252. The charging control circuit can be deactivated upon a charging control signal provided by control circuit 251. The control circuit 251 also receives a charging state signal from charging control circuit 252.

Said control circuit 251 is coupled to the contact pins 126 to the rechargeable battery 15 and to the sensor unit 40 via the connector pad 125. The control circuit receives several status signals of the respective electronic devices indicating a currently ongoing functionality. Such functionality could be for example a transmission of data from one of the electronic devices to another device or a transmission of data from the first electronic device to a cloud. As long as such functionality is still ongoing and the device is not finished, the control circuit will prevent changing the mode, i.e. will refrain from generating a command forcing any other circuitry to enter hibernation.

Likewise, the control circuit is evaluating the charging level of the battery indicated either by the charging control circuit 252 or directly by the voltage provided by battery 250. The control circuit 351 in the second electronic device as explained further below may also provide a respective signal indicating the charging state of the battery 350 via the bus interface 151. Finally, the control circuit 251 may receive a status signal via the bus interface 151 from the sensor unit 40.

The second rechargeable electronic device 30 also comprises a certain functionality implemented by respective circuitry. For example, the second electronic devices 30 may include a portable microphone that can be attached to a user. A communication interface (not illustrated herein can be used to either transmit the recorded speech to a receiver, for example the first electronic device or store the recorded speech in a memory for later transfer using the wired connection provided via connector pads 135 and the casing bottom part 11. Second electronic device 30 also comprises a rechargeable battery supplying power to its internal functions. The control circuit 351 in the second electronic device 30 provides the necessary functionality and is configured not only to control charging of the battery 350, but also configured to hibernate the internal circuitry of the second electronic device upon a respective signal from the interface of the casing bottom part, said hibernation request provided by the control circuit 251.

The bus interfaces of the respective electronic devices 20 and 30 as well as the casing bottom part 11 may be the same to simplify communication between them. Otherwise, a translation interface is necessary to ensure proper communication and data transfer between the devices. Apart from the USB interface, other examples of suitable bus interfaces and protocols may include SPI, I2C, UART, CAN, LIN, I2S and its derivates. Some of those protocols are suitable only for data communication but not power supply transfer i.e. for charging batteries. In such cases, additional lines are provided which can manage larger currents. Other protocols like USB are suitable for both that is data and power supply transfer.

In operation a user may accommodate the first electronic device and optionally one or more second electronic devices within their respective recesses. The control circuit 251 might receive a respective “connect to the casing signal” indicating that the first electronic device has been placed in the recess and the connection between pads 125 and 126 has been established. The control circuit 251 may also receive a respective status signal from the charging control circuit 351 indicating that the second electronic device has been placed in the recess and power supply and data connection is established. Such status signals may also include information about the battery status of the rechargeable batteries 250 and 350, respectively. The status signals are periodically updated.

In response thereto to those signals, the control circuit 251 will trigger the recharging of the respective batteries 250 and 350. In an alternative approach, the two electronic devices are placed within the recess establishing power supply and data connection via the respective contact pads. The charging control circuits 252 and 351 are able to recognize the power signals on the power lines of the supply connection and initiate charging of the respective batteries without explicit triggering from the control circuit 251. Still, both charging control circuits 351 and 252 provide periodic updates of the charging status of the batteries to the control circuit 251. The status signals indicate the voltage levels of the batteries, which correspond to the respective charging state.

The charging of the batteries will continue until a pre-determined charging state is reached. The charging state may either be set by the control circuit 251, that is the control circuit will provide a “stop charge” signal to charging control circuits 252 and 351 upon indication of reaching the pre-determined charging state. Alternatively, the charging control circuits evaluate the charging state of the batteries and stop charging by themselves accordingly.

The above charging process is generally conducted irrespectively of the status of the casing arrangement that is irrespectively whether the casing is open or closed. If a user places the casing top part on the casing bottom part, thereby covering the electronic devices, the sensor unit 40 provides a respective status signal to the control circuit 251 indicating the casing has been closed. At this point, the control circuit evaluates the charging state of the first and second electronic devices to determine whether the respective charging state has been reached. It optionally also determines whether the respective electronic device currently performs another function that cannot or should not be interrupted. Such function may include for example compression of data, pre-processing of data that are otherwise lost or become corrupt or transmission of data via a wireless connection to a network node for storage and processing.

The control circuit may periodically request a status update of such functions being currently executed by the electronic device. Upon finishing the execution of such function, the control circuit determines if the casing is still closed, and the predetermined charging state has been reached. If the conditions are met, the control circuit 251 will initiate a hibernation mode for the first and second electronic devices to significantly reduce the power consumption.

Upon detection that the casing is opened again, the sensor unit will trigger a revised status signal over the bus interface to the control circuit 251. In response to such revised status signal, the control circuit will provide a wake-up signal to the first and second electronic device initiating a boot-up of the devices. A user may then remove the devices from the casing and then continue to use them without the need to switch on them manually.

Apart from the hibernation signals, the control circuit may also provide further command and control signal based on the status signal provided by the sensor unit 40 and the charging states. For example, the control circuit may forward the signals indicating a charging state to a display of the first electronic device as long as the casing is open. A user can therefore easily obtain information about the charging and possible other states (e.g. indicating that certain functions are currently executed like the ones mentioned exemplary above) of the electronic devices.

Upon reception of the status signal by sensor unit 40 indicating that the casing is closed, the control circuit can trigger a switch of for a display or a user interface of the first and/or second electronic devices. Other modules and functions that are powered but at this stage no longer required may also receive a power-down signal to reduce the overall power consumption. When no other function is executed or otherwise preventing hibernation of the electronic device, the control circuit will issue a hibernation signal to the device once the conditions are met, namely the pre-determined charging state and the “casing closed” status signal.

FIG. 4 illustrates a similar example with a casing arrangement 11 having a recess with an electronic device 20 accommodated therein. The rechargeable electronic device is a recording device and comprises a plurality of spatially separated microphones coupled to a processor for storing the recordings into a non-volatile memory. The device also comprises a wireless interface configured to communication with an access point and network node to upload the recordings stored in its memory. Memory, processor, and wireless communication interface are not illustrated therein, the recording device also comprises the rechargeable battery and the control circuit 351 in accordance with the proposed principle. The recording device also comprises an additional sensor 24 that is also coupled to the control circuit 351. The additional sensor unit may comprise an ambient light detector and can for example be used to set the illumination of the display or even switch it off, e.g. when no ambient light is detected.

Casing bottom part 11 comprises a sensor unit 40 configured as a light sensor or as a magnetic sensor for example for determining whether the casing arrangement is closed or opened. Both sensor units 40 and 24 are coupled to the control circuit 351 being part of the first electronic device 20. Control circuit 351 is also coupled to the processor, memory, wireless interface and further circuitry to control its status and particularly set the respective circuitry into hibernation if needed. The communication can utilize the same bus system as the bus between the casing bottom part 11 and the electronic device 20. Alternatively, control circuit 351 may include the internal power supply unit configured to the set into hibernation and thus shut down the main function of device 20.

When the casing top part is arranged on the casing bottom part, both sensor units 24 and 40 will detect a decline in ambient light and provide a respective signal to the control circuit via bus 151. The decline of both signal will provide a higher confidence that the decline in ambient light is not an accidental coverage, but the real closing of the casing. If a magnetic sensor is used as unit 40, such confidence is even higher, because control circuit 351 now evaluates two status signal derived by different measurement techniques.

Upon evaluation that the casing is closed, control circuit 351 determines the charging state of the rechargeable battery and also requests a task update form all other modules, i.e. the processor and/or the wireless module. If no tasks are currently performed (for example, transmission of recorded files to a network node taking place) the control circuit indicates a “reduce power” signal requesting the processor not to initiate further tasks or processes. Likewise, the control circuit may initiate a sleep mode for certain modules, which are currently not used to reduce power consumption. If processes are still active and running, the control circuit initiates either a “suspend” signal where possible or request a “status update” on completion of the respective process. Similar to the previous, a “reduce power” signal is provided by the control circuit 351 to the processor requesting not to initiate further tasks or processes.

Finally, when all processes are completed, the electronic device is set into hibernation. This process can be performed for each of the electronic devices by the control circuit 351 separately and independently form the status of the other devices. Consequently, some devices are set into hibernation, while other are still recharging of even performing certain tasks.

FIG. 5 illustrate an embodiment for a schematic exemplary process for operating a rechargeable electronic device accommodated in a recess of a casing bottom part of a casing arrangement, the rechargeable electronic device is in an electrical connection with the casing bottom part via a bus interface. Further, the casing bottom part is configured to recharge the electronic device accommodated within the recess.

After the electronic device has been placed within the recess, the electronic device is charged instep S1 in response to a charge state signal. This signal indicates the charging level of the batteries, by evaluating for example the voltage provides by the rechargeable battery of the electronic device. If the charge state level is below a threshold the battery is charge otherwise, charging is stopped to the extent that the charging level of the rechargeable battery is maintained.

When a user now covers the bottom casing part by closing casing with the casing top part, a first sensor signal is generated in step S2 indicative that the casing bottom part is covered by a casing top part. Said signal is also provided in step S2 to a control circuit. Said control circuit can be part of a processor and its functionality at least partially implemented in software. Alternatively, the control circuit can be a dedicated circuitry implemented in hardware. The control circuit can be implemented in the casing bottom part, whereas it is connected via a bus interface to the electronic device and to a sensor providing the sensor signal. The control circuit can also be implemented within the electronic device itself.

In response to the received first sensor signal and the pre-determined charging state of electronic device will now set in step S3 the electronic device to hibernation that is shut-off all functions and powers down the electronic device except for the power to itself. It will also terminate any recharging or maintenance charging should it still occur. Power of consumption the electronic device is significantly reduced in such hibernation mode.

The control circuit will then wait in step S4 for a change in the status signal indicating that the casing has been opened again. For this purpose it may evaluate the status signal in step S5 after having waited in steps S4 for a certain period. Said period can be 1 second or 2 seconds for example. If no change is detected, the control circuit restarts the loop. If a change of the status signal is detected, indicating that the casing has been opened, the control circuit will execute a start-up procedure in step S5 by restoring power to the electronic device.

In some further aspects, the shut-down procedure initiated by the control circuit in step S3 will be execute individually and separately for each electronic device coupled to said control circuit via the bus interface. For example, in a further embodiment of the proposed principle, at least one further electronic device is accommodated in a recess of a casing bottom part of a casing arrangement. In response to the received first sensor signal in steps S2 and a pre-determined charging state of electronic device will hibernate the at least one further electronic device in step S3 and terminating any recharging and optional maintenance charging of the at least one further electronic device.

With the method and the casing arrangement in accordance with the proposed principle, it becomes possible to ensure a low power consumption of an electronic device in particular one or more electronic devices during transportation when those devices are stored in a casing arrangement. At the same time, the user does not need to wait until all task and processes are performed by the electronic device before placing it into the casing. Rather, the device continues to process its task given by the user when accommodated within the casing until either finished or being no longer able to (e.g. when the device is out of range for a wireless connection). Still charging is also performed enabling the user to utilize the full capacity of the device when removing it form the casing. The electronic device still is set into hibernation allowing for a longer time storage without a manual shut-down. The proposed approach provides an easy-to-use functionality leaving the user to focus on the content and the overall tasks but not on technical or power constraints.

The casing can be generally used for all kinds of electronic devices, including but not limited to recording devices like speech or voice recorder, cameras and the like, but also for conferencing systems wearables and consoles accessories as VR displays and joysticks to name a few.

### LIST OF REFERENCES

10 casing top part
10a gripping handle
10b mechanical clamps
10c protrusion
10d protrusion
11 casing bottom part
11a circumferential edge
11b surface
11c protrusion
11d material bridge
12 charging plug
15 rechargeable battery
20 first electronic device
24 sensor
30 second electronic device
40 sensor
120 central recess
125 connector pad
126 contact pins, connector pad
130 recess
132 slides
135 connector pads
150 charging control circuit
151 bus
250 battery
251 control circuit
252 charging control circuit
350 battery
351 control circuit

1. A portable casing arrangement, comprising:
a casing bottom part with a stand and further having a first recess configured to accommodate a first rechargeable electronic device therein; and
a casing top part configured to be attached to the casing bottom part opposite the stand for covering said first rechargeable electronic device accommodated in said recess;
a sensor unit arranged in the casing bottom part and configured to provide a status signal in response the casing top part being attached to the casing bottom part;
wherein said casing bottom part is configured to recharge the first electronic device when accommodated in said first recess based on a respective recharging signal provided by a control circuit; and
wherein the control circuit is configured to hibernate the first electronic device and terminate any recharging of the first electronic device in response to the status signal indicating that the casing top part is attached to the casing bottom part, a pre-determined charging state of the first electronic device, and a status signal indicating completion of pre-determined functions.

2. The casing arrangement according to claim 1, wherein the control circuit is arranged in the first electronic device.

3. The casing arrangement according to claim 1, wherein the pre-determined charging state is indicative of a voltage level of the rechargeable battery.

4. The casing arrangement according to claim 1, wherein:
the casing bottom part comprises at least one second recess configured to accommodate a second rechargeable electronic device therein; and
said casing bottom part is configured to recharge the second electronic device when accommodated in said second recess based on respective recharging signal provided by the charge control circuit.

5. The casing arrangement according to claim 4, wherein the control circuit is configured to obtain a charging state signal from the first electronic device and/or the second electronic device indicative of a state of a rechargeable battery placed in the respective first and second device.

6. The casing arrangement according to claim 5, wherein the control circuit is configured to hibernate the second electronic device and terminate any recharging of the second electronic device in response to the status signal indicating that the casing top part is attached to the casing bottom part and a pre-determined charging state of at least one of the first and the second electronic device.

7. The casing arrangement according to claim 1, wherein the casing bottom part comprises a rechargeable battery and a charging controller for charging the rechargeable battery when the casing bottom part is connected to a power supply, in particular a USB port or a USB Power Delivery connection.

8. The casing arrangement according to claim 1, wherein the sensor unit is configured to provide a first status signal, said first status signal indicating that the casing top part is attached to the casing bottom part and a second status signal, said second status signal indicating that the casing top part is removed from the casing bottom part.

9. The casing arrangement according to claim 8, wherein the control circuit is configured to wake-up at least one of the first and second electronic devices, when the respective electronic device is hibernated and in response to the second status signal.

10. The casing arrangement according to claim 1, wherein the sensor unit comprises at least one of:
a light detector;
an infrared detector;
an infrared transceiver;
a hall sensor; and
a mechanical push or pull sensor.

11. The casing arrangement according to claim 1, wherein the casing top part is opaque and
optionally a reflective portion facing the sensor unit; and/or
optionally comprises a protrusion along the inner wall of the top part at a location at which the distance between its surface and the sensor unit is less than 5 cm and in particular less than 2 cm and in particular less than 1 cm when the casing top part is attached to the casing bottom part.

12. The casing arrangement according to claim 4, wherein the first recess and/or the at least second recess comprises means for pulling the respective electronic device towards a bottom of the recess when the respective electronic device is located with its bottom portion in the recess at a level slightly below the top surface of the recess.

13. The casing arrangement according to claim 4, wherein the first and/or the second recess comprises a plurality of electric connectors, in particular pogo-pins for electrically connecting the respective electronic device when arranged in the respective recess.

14. The casing arrangement according to claim 12, wherein one of the first recess and the electric connectors are shaped and/or located such that they ensure a non-rotating arrangement of the respective electronic device in the respective first and second recess.

15. The casing arrangement according to claim 4, further comprising at least one communication bus for communicating with the first and/or second electronic device, when the communication bus comprise one of:
USB;
SPI; and
I2C.

16. An electronic device, in particular a recording device for recording audio and/or video data configured to be placed into a casing arrangement according to one of the preceding claims, the electronic device comprising:
an electrical connector for communicating from and to and transferring power from the casing arrangement;
a rechargeable battery coupled to the electrical connector for being recharged by the casing arrangement;
a control circuit configured to:
control the charging of the rechargeable battery by the casing arrangement when the electronic device is arranged in the casing arrangement, and
hibernate the electronic device and terminate any recharging of the electronic device in response to a status signal provided by the sensor unit arranged in the casing bottom part of the casing arrangement indicating that the casing arrangement is closed, a pre-determined charging state of the electronic device, and a status signal indicating completion of pre-determined functions.

17. The electronic device according to claim 16, wherein the control circuit is further configured to:
control the charging of a rechargeable battery of a second electronic device accommodated in the casing arrangement by the casing arrangement using respective control signal through the electrical connector; and
hibernate the second electronic device through the electrical connector by a respective control signal and terminate any recharging of the second electronic device in response to a status signal provided by the casing arrangement indicating that the casing arrangement is closed, a pre-determined charging state of one of the first and second electronic devices, and a status signal indicating completion of pre-determined functions.

18. The electronic device according to claim 16, wherein the control circuit is configured to determine voltage level of the rechargeable battery and compare the determined voltage level with a threshold value and is further configured to control the charging current based on the comparison result.

19. (canceled)

20. (canceled)

21. (canceled)

22. (canceled)

23. (canceled)

24. (canceled)

25. A method for operating an electronic device accommodated in a recess of a casing bottom part of a casing arrangement, the electronic device in electrical connection with the casing bottom part; said method comprising:
recharging the electronic device in response to a charge state signal;
generating a first sensor signal by the casing bottom part indicative that the casing bottom part is covered by a casing top part;
providing the first sensor signal to the electronic device via the electrical connection;
in response to the received first sensor signal, pre-determined charging state of electronic device, and a status signal indicating completion of pre-determined functions:
hibernating the electronic device; and
terminating any recharging of the electronic device.

26. The method according to claim 25, wherein
at least one further electronic device is accommodated in a recess of a casing bottom part of a casing arrangement and in response to the received first sensor signal, a pre-determined charging state of electronic device, and a status signal indicating completion of pre-determined functions:
hibernating the at least one further electronic device; and
terminating any recharging of the at least one further electronic device.

27. (canceled)
